(19) United States
(12) Patent Application Publication
(10) Pub. No.: US 2026/0326662 A1
(43) Pub. Date: Oct. 22, 2026

(54) LIGHT ASSEMBLY FOR ILLUMINATING PANES FOR AUTOMOBILES

(71) Applicant: MERCEDES-BENZ GROUP AG, Stuttgart (DE)

(72) Inventors: Markus SCHÖNEICH, Sindelfingen (DE); Alexander THEILE, Böblingen (DE); Daniel BETZ, Rottenburg-Seebronn (DE)

(21) Appl. No.: 19/109,805

(22) PCT Filed: Jul. 11, 2023
(86) PCT No.: PCT/EP2023/069207

§ 371 Date: Mar. 7, 2025

(30) Foreign Application Priority Data
Sep. 9, 2022 (DE) 10 2022 003 315.1

(51) Int. Cl. B60Q 1/26; F21S 43/235; F21S 43/31

(52) U.S. Cl. CPC B60Q 1/268; F21S 43/235; F21S 43/31; B60Q 2400/50

(57) ABSTRACT

A light assembly for illuminating surfaces and/or light-based media includes a light source, circuit board, at least one lens, and at least one reflector element. The light source, circuit board, and the at least one lens are arranged in a housing. At least one holder element is provided enabling the housing to be fastened to a glass carrier in a precise position.

### BACKGROUND AND SUMMARY OF THE INVENTION

Exemplary embodiments of the invention relate to a light assembly for illuminating surfaces and/or light-based media.

In principle, light assemblies for illuminating surfaces and/or light-based media are known from the prior art. In the automotive sector, the surface may, for example, be a windowpane, another glass, or plexiglass pane. In the illustration, it may be any type of light signal and/or warning signal created by light rays. The light signal or the warning signal can be projected onto a window of a motor vehicle, for example.

US 2018/0086028 A discloses a light source coupled to glazing of a vehicle. The light source is a diode arranged laterally next to the glazing. A diffuser or a reflector is arranged on a surface of the glazing and spaced apart from the light source. The light of the light source is introduced via an edge surface into the glazing and is extracted or discharged via the diffuser from the glazing.

Since the diffuser or the reflector is arranged spaced apart from the light source, an exact orientation of both elements is essential. A disadvantage, however, can arise from installation space restrictions, which also result from geometric curvatures in the context of a curved pane, for example. Similarly, production-related tolerances can affect the light discharged or extracted from the glazing, which leads to a deviation in the light appearance. In particular, therefore, additional components may be necessary in order to ensure exact light guidance. Overall, absolute tolerance effects are therefore mostly not included, which reduces the photometric efficiency.

Exemplary embodiments of the present invention are directed to an improved light assembly for illuminating surfaces and/or light-based media, which overcomes the aforementioned disadvantages.

Fundamental to the light assembly according to the invention is that a light source, a circuit board, and at least one lens are arranged in a housing, wherein at least one holder element is provided that enables the housing to be fastened to a glass carrier in a precise position. Advantageously, therefore, installation space restrictions can be avoided since all elements are arranged compactly in one housing. For example, an increase in the photometric efficiency can be achieved by optimized position tolerance and optimized reflector characteristics, since only one compact element, i.e., the housing, has to be fastened to the glass carrier.

The at least one holder element serves in particular as a mold holder for the housing, wherein fixing of the housing can be enabled by targeted application of force by the at least one holder element to the housing, in particular by clamping. Similarly, industrial alignment and tolerance compensation of the components can take place by means of a targeted application of force.

The light assembly for illuminating surfaces and/or light-based media comprises at least one light source, a circuit board, at least one lens, and at least one reflector element. All of these elements, except for the reflector element, are arranged completely in the housing. The at least one lens serves for optical light distribution and can be designed as a microlens. The reflector element contacts the light guide element and is therefore similarly directly connected to the housing of the light assembly. Therefore, simple and flexible subsequent replacement is possible, without damaging the optically relevant surfaces of the glass carrier. Similarly, advance preparation of the glass carrier by cleaning or treating the surface for example, can be dispensed with, since the housing can be easily removed from the at least one holder element without additional components and attachments and thus can be easily replaced.

Preferably, a light guide element can be arranged in the housing. The light guide element in particular contacts the circuit board and in particular is completely surrounded on at least one side by the housing and is delimited by the reflector element and the glass carrier on at least one other side. Therefore, in particular dissipation of light rays can be prevented since the housing forms a shielding sleeve outside the glass carrier.

According to a very advantageous development of the idea, it can be provided that the reflector element contacts the light guide element. The reflector element in particular is arranged on a side region of the light assembly when the housing is held on the glass carrier by the at least one holder element. Therefore, it is arranged in the same region as the housing on the glass carrier.

It can be provided according to an advantageous embodiment that the circuit board and/or the housing have a white surface. As a result, the reflective characteristics can be increased or improved. This leads to an increase in the efficiency of the entire system. As an alternative to a white surface, it may also be sufficient to make the surfaces of the circuit board and/or the housing relatively light in color.

According to a very advantageous development of the invention, it can be provided that the at least one holder element is glued and/or clamped to the housing. Advantageously, the housing is fixed to the holder element on the glass carrier, in that the holder element is firmly connected to the glass carrier and the housing is held clamped on the holder element. Therefore, a simple exchange of the housing and thus of the complete light assembly can be carried out. This enables a cost-effective service possibility.

A further advantageous embodiment can provide that two holder elements are comprised, which are arranged on two opposing sides on the housing. Therefore, the housing can be held clamped between the two holder elements. For example, the holder elements can be fixed to the glass carrier in such a way that they exert a compressive force on the housing when the housing is located between the holder elements.

According to an advantageous embodiment, it can be provided that the at least one holder element can be attached to the glass carrier in a precise position. Therefore, exact positioning of the housing, and thus of the light assembly, on the glass carrier is possible. When determining the position at which the housing is to be fastened, curvatures of the glass carrier, such as the curvatures of a vehicle pane, can be taken into account.

According to a very advantageous development of the invention, it can be provided that the two holder elements can be non-releasably glued to the glass carrier in a predetermined position. In particular, the at least one holder element, for example both holder elements, is non-releasably glued to the glass carrier. Therefore, the position can remain unchanged.

A further advantageous embodiment can provide that the holder elements can each be designed in the form of a hook, wherein the housing can be held clamped and fixed between the two holder elements. An L-shape, for example, can also be understood as a hook shape, wherein each hook element has two sections, in particular at a right angle to each other. One of the sections can run along a first side surface of the housing, the second section can run along an adjacent side surface of the housing. The second section has in particular a free end, so that each of the holder elements can be designed to be elastically movable. The holder elements can contain metal and/or plastic, for example.

It can be provided according to an advantageous embodiment that the at least one holder element exerts a restoring force on the housing, in order to fasten and hold the latter in a precise position. In particular, in this case two L-shaped holder elements can be designed such that they mirror each other, so that the two restoring forces of the two holder elements are aligned with each other. Therefore, a clamping force of the two holder elements can be exerted on the housing arranged in between.

### BRIEF DESCRIPTION OF THE DRAWING FIGURES

Further advantages of the light assembly according to the invention furthermore result from the remaining dependent claims and become clear with reference to the embodiment examples which are described in more detail below with reference to the figures, in which:

FIG. 1 shows a possible embodiment of the light assembly;

FIG. 2 shows a further possible embodiment of the light assembly;

FIG. 3 shows a further possible embodiment of the light assembly.

### DETAILED DESCRIPTION

FIG. 1 illustrates a possible embodiment of the light assembly 1. A light source 2, a circuit board 9, and several lenses 3 are arranged inside a housing 5. Furthermore, a light guide element 8 is arranged inside the housing 5 in such a way that it is delimited by a side of the housing 5 and by at least one further side of a reflector element 4. The reflector element 4 is located on at least one glass carrier 7, wherein a further glass carrier 7′ is provided in this embodiment. The reflector element 4 is at least partially arranged between these two glass carriers 7, 7′, wherein the glass carrier 7′ can contain a polymethyl methacrylate (PMMA) or a polycarbonate (PC). Similarly, a design consisting of glass is conceivable.

The glass carrier 7 serves to introduce light rays 10 and in particular is designed to conduct light. The light source 2 can, for example, be designed as an LED, for example as at least one side-emitting or top-emitting LED. The light rays 10 are guided from the light source 2 through the several lenses 3 and through the light guide element 8 up to the reflector element 4. There, the light rays 6 reflect and are introduced into the glass carrier 7.

In particular, undesired irradiation of the light rays 10 outside the light assembly 1 can be prevented by a peripheral housing section 5′. Since all of the components are fully enclosed inside the housing 5, the optical functions are almost completely arranged in the housing 5. Therefore, an increase of the photometric efficiency and tolerance compensation can take place. Furthermore, the light assembly 1 can be arranged in a space-saving manner as a compact component.

The housing 5 can be formed from a thermoplastic material and contain webs and hollow spaces. The webs can form holders or mounts for the components, such as the circuit board 9 and/or the light source 2.

The housing 5 is held in this embodiment via two holder elements 6, wherein the holder elements 6 can be designed in the form of hooks. In particular, each of the holder elements 6 is designed in an L-shape, wherein the holder elements 6 are arranged mirroring each other. A restoring force is illustrated by an arrowhead shown at a free end of each holder element, wherein the housing 5 is held clamped by the two holder elements 6.

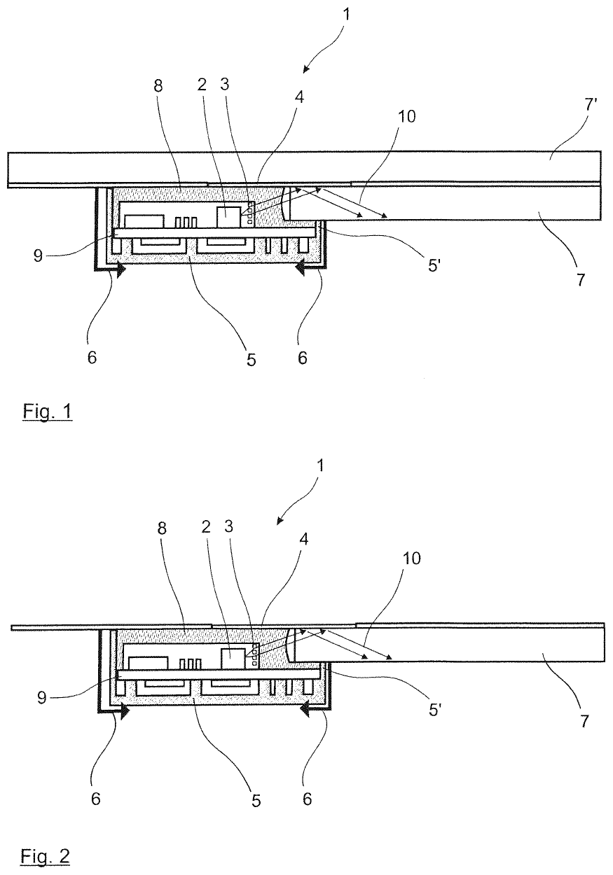

A further embodiment variant of the light assembly 1 can be seen in FIG. 2. The same components are provided in this case with the same reference numerals, so this does not have to be discussed in further detail. In contrast to FIG. 1, here the glass carrier 7′ is not present. Despite this, the light rays 10 can be introduced into the glass carrier 7 via the reflector element 4. Therefore, the glass carrier 7′ has a protective function, in particular as a protective layer, however in particular not as a light-conducting layer.

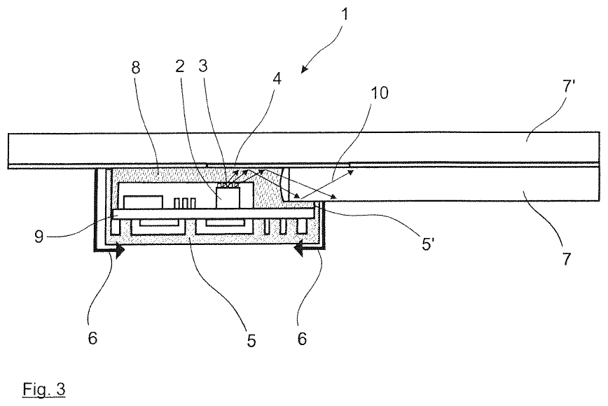

A further embodiment of the light assembly is represented in FIG. 3. In contrast to the embodiment according to FIGS. 1 and 2, the lenses 3 are arranged at another position in the housing or at another position in relation to the light source 2, respectively. Therefore, light from the light rays 10 can be introduced into the glass carrier 7 in a different way than in FIGS. 1 and 2.

Clearly, the described embodiment variants of the light assembly 1 in FIGS. 1 to 3 can also be combined among themselves, so that different possibilities arise. For example, the embodiment according to FIG. 3 can be designed without the glass carrier 7′. Furthermore, for example, the arrangement and the number of lenses 3 can vary.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A light assembly configured to illuminate surfaces or light-based media, the light assembly comprising:
a light source;
a circuit board;
at least one lens;
at least one reflector element;
a housing, wherein the light source, the circuit board, and the at least one lens are arranged in the housing; and
at least one holder element configured to allow the housing to be fastened to a glass carrier in a precise position.

12. The light assembly of claim 11, further comprising:
a light guide element arranged in the housing.

13. The light assembly of claim 12, wherein the at least one reflector element contacts the light guide element.

14. The light assembly of claim 11, wherein the circuit board or the housing have a white surface.

15. The light assembly of claim 11, wherein the at least one holder element is glued or clamped to the housing.

16. The light assembly of claim 11, wherein the at least one holder element comprises two holder elements arranged on two opposing sides on the housing.

17. The light assembly of claim 11, wherein the at least one holder element can be attached to the glass carrier in a precise position.

18. The light assembly of claim 16, wherein the two holder elements are non-releasably glued to the glass carrier in a predetermined position.

19. The light assembly of claim 16, wherein the two holder elements each have a form of a hook, wherein the housing is holdable clamped and fixed between the two holder elements.

20. The light assembly of claim 11, wherein the at least one holder element is configured to exert a restoring force on the housing to fasten and hold the housing in a precise position.
